(19) United States
(12) Patent Application Publication
(10) Pub. No.: US 2004/0135704 A1
(43) Pub. Date: Jul. 15, 2004

(54) System and method for providing travel information on a mobile communication device

(75) Inventor: Michael Fischer, Mettmenstetten (CH)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS SCHWEIZ AG, ZUERICH (CH)

(21) Appl. No.: 10/740,487

(22) Filed: Dec. 22, 2003

Related U.S. Application Data
(63) Continuation of application No. PCT/EP02/03222, filed on Mar. 22, 2002.

(30) Foreign Application Priority Data
Jul. 2, 2001 (EP) 01 116 069.4

(51) Int. Cl. G08G 1/123

(52) U.S. Cl. 340/994

(57) ABSTRACT

The invention relates to a system that enables a user wishing to travel to input, without knowing his exact location, only the desired destination into the mobile communication device and to then receive a timetable for reaching the destination that takes into consideration the actual position of the means of transport in question. The user can thus benefit from the actual position of the means of transport in question that are known to the guide devices anyway.

### CROSS REFERENCE TO RELATED APPLICATIONS

The present application is a continuation of international application PCT/EP02/03222, filed Mar. 22, 2002, which designated the United States and further claims priority to European priority document 01116069.4, filed Jul. 2, 2002, the both of which are here incorporated by reference.

### BACKGROUND OF THE INVENTION

The invention relates to a system and a method for providing travel information on a mobile communication device. Such systems are currently also known as “electronic timetables” and are offered for example by companies such as “Mantz Datenverarbeitung GutbR (www.mentzdv.de)” and “Häni-Prolectron AG (www.hpw.ch). These systems are designed as travel information systems to aid users when planning their journey and to provide them with additional information during their journey. These systems determine complete travel routes and provide information about changes at the transfer points.

The information comprises an overview of the travel options arranged in a table format; it contains detailed information in a table format, a general map, a detailed map showing the start and end locations, a location map and tariff information. The information can either be listened to over and over again on a mobile phone or read as an SMS message on the mobile phone display.

The disadvantages of these types of systems are however that travelers using means of public transport must know their exact starting point for the journey and access to quasi-static timetable data can sometimes differ significantly from current public transport connections.

### BRIEF SUMMARY OF THE INVENTION

The object of the present invention is to offer a system and a method for providing travel information on a mobile communication device that offers particularly efficient planning for a journey and travel to the destination.

With regard to the system of the prior art described in the introduction, the object according to the present invention is achieved in that

a) a destination location can be entered in the communication device and transferred to a control computer,

b) a current location can be assigned to the communication device in the control computer,

c) the control computer has access connections to route control facilities for public transport,

d) the current locations of the means of public transport can be called up from the route control facilities via the control computer,

e) depending on the current locations of the means of public transport, an individual timetable can be generated using suitable means of public transport to reach the destination, and

f) the timetable for the suitable means of public transport can be transferred to the mobile communication device where it can be seen and/or heard.

This system means that travelers only have to enter their destination into the mobile communication device and do not need to know their exact location. Travelers receive a timetable to reach their destination that takes into consideration the actual locations of the relevant means of public transport. The traveler therefore benefits from the current positions of the relevant means of public transport known to the route control facilities for public transport. This means that users no longer have to obtain information from the guard about the effects of a delay to the current train or to a connecting train anticipated at the transfer point; information which the train guard often does not know anyway.

In a preferred embodiment of the invention, the mobile communication device will have a location detection module and will transmit information regarding the current location to the control computer. A GPS module integrated into the mobile communication device or location via GSM-R is for example suitable for this type of location detection. Another option is to assign the location of a send/receive unit with which the mobile communication device is currently communicating as the current location of the mobile communication device.

In a particularly beneficial further development of the invention, the individual timetable will be re-generated during the journey and if an update is needed, the updated timetable will be transferred to the mobile communication device. In this way, changes to the planned itinerary can be incorporated at any time. Such changes could include the delayed arrival of a connecting train at a transfer point or the cancellation of a connecting train that means that the traveler has to stay on the current means of transport to a next suitable transfer point and then transfer to another means of transport to avoid losing time or incurring inconvenience on the route to the destination where possible. To avoid incurring any inconvenience, it is particularly beneficial if the updated timetable is only transmitted up to a specifiable time before arriving at the transfer point. This spares travelers any hectic changes to different means of transport. This would apply for example to a family with young children who require a certain length of time before the transfer to make getting out at the transfer point as easy as possible. This surely also applies to the elderly who may have limited mobility affecting their travel.

To enable the control computer to assign the current location of the user as reliably as possible, it is also possible for the location of the mobile communication device (currently traveling on a means of public transport) to be evaluated as being on this particular means of public transport by the control computer by correlation with the current location of the means of public transport and therefore for probable arrival times at the next possible transfer point(s) to be determined. From the location information transmitted by the mobile communication device and the agreement of this current location with the actual location of the means of public transport, it can be assumed that the user is traveling by this means of transport. It is then possible for the control computer to determine directly when the user will reach the planned transfer point. This agreement of the current location of the mobile communication device and the means of public transport is requested at least twice before a conclusion is reached as to the presence of the traveler in a particular means of transport. This avoids errors arising from different means of transport traveling in parallel or across each other.

A particularly beneficial embodiment of the both the method and the system proposes that after issuing the individual timetable a seat reservation with confirmation is made using the mobile communication device for the planned means of public transport. In particular, in the event of a change to the transport itinerary because of train delays, cancellations or diversions, an attempt can still be made to remake a reservation for the new means of transport. Confirmation for the reservation and the exact reservation data can also be transmitted to the mobile communication device and recalled and/or stored there or in the control computer. Entering the reservation can be made easier if a reservation profile is stored on the control computer that can be recalled and a search made according to the predefined reservation criteria.

### DETAILED DESCRIPTION OF THE INVENTION

Further embodiments of the present invention will now be described in more detail. A first example illustrates a journey by train from Münster/Westf. to Nürnberg via Hamm/Westf., Kassel-Wilhelmshöhe and Würzburg. In this embodiment, a service number is dialed at around 8 a.m. from a mobile phone that activates the service to provide travel information. This service asks the mobile phone user to enter the desired destination. The user enters Nürnberg and transmits this information together with the location information obtained using a GPS module integrated in the mobile phone to a control computer for this service. A few seconds later, the user receives the next available travel options as the following timetable:

| | FROM | | TO |
|---|---|---|---|
| 08:35 AM | MS-Prinzipalm. | 08:50 AM | MS-Hbf. |
| 09:05 AM | Münster/Westf. | 09:37 AM | Hamm/Westf. |
| Approx. | Hamm/Westf. | Approx. 12:25 PM | Kassel/Wilh |
| 10:10 AM | | | |
| 13:20 PM | Kassel/Wilh | Approx. 15:25 PM | Nürnberg |

So the traveler using this service now knows that to take the bus from the “Münster-Prinzipalmarkt” stop at 08:35 AM to the Hauptbahnhof (main Station) to arrive at 08:50 AM. There then is a train from Münster to Hamm, then a change to another local train to Kassel-Wilhelmshöhe and from there an inter-express city train to Nürnberg. The user receives notification on the mobile phone approximately 5 minutes before each transfer point of the imminent change.

The service activated on the mobile phone, or more accurately on the control computer supporting this service, now accesses the available route data from the Verkehrsverbund Münsterland (Münster Passenger Transport Executive) of the Train Control Centers in Hamm, Kassel-Wilhelmhöhe and Nuremberg. The departure and arrival times marked with the abbreviation “approx.” show the user at the time of the enquiry that this train is no longer adhering to the published timetable but that there is a deviation from the timetable. In this case, the train will leave Hamm 15 minutes late. The control center will know about this delay because for example the local train from Aachen had to wait for 15 minutes longer in Düsseldorf because of a signaling problem or a technical problem with the locomotive. This delay of 15 minutes will unfortunately mean that in Kassel-Wilhelmshöhe the intercity express train from Hamburg to Munich will now not meet its otherwise possible departure time of 12:20. The user can already, at this early stage, adjust to a longer wait in Kassel-Wilhelmshöhe than planned. At the same time, the early knowledge of this change can for example enable to make a reservation on the new intercity express train that is Kassel-Wilhelmshöhe one hour later. The reservation function on the service can be activated and where still possible the reservation will be displayed as an SMS message and then booked with confirmation regarding seat and payment.

The user is notified before the stop in Hamm of the imminent transfer and gets on the delayed local train (the delay is already known). During the journey of around two hours, the activated service informs the user about a change to the timetable in good time before the transfer at Kassel-Wilhelmshöhe. Since the intercity express train between Hanover and Göttingen has for example lost 10 minutes because of unplanned tunnel works, the connection with the original intercity express train in Kassel-Wilhelmshöhe will be possible after all. This service once again makes it possible to obtain information early, without searching for and troubling the train guard. The user does not need to rely on the sometimes inadequate announcements on the train regarding the changes.

This change to the original timetable is only possible because there is access to the available route data and the service constantly determines the current location of the traveler and so can estimate when the user and the relevant means of transport will arrive at the transfer point relevant to the user.

A second example shows that of course rail data and flight data can be combined. A traveler in Kassel can for example activate the service to find out the quickest way to reach London. From Kassel there are three airports that the traveler could reach relatively quickly, namely Hanover, Frankfurt and Nuremberg. By entering London, the control computer now requests the available route data from air traffic control and the appropriate rail data and so decides for the traveler from which of these three airports the flight to London will leave. A timetable is generated with suitable rail connections and the connecting flight. This saves the traveler considerable time, firstly because he can reach his destination quicker and secondly because he does not have to find out the information for himself which for the possible airports and the rail connections can be relatively cumbersome using WAP.

Furthermore, the user is completely independent from these services and is always informed about what is happening. Furthermore, it is valuable for non-local users who do not need to know their exact starting location since the transmission of current location data is a feature of the service. There are various possible options to make location detection more or less precise. The location detection process is very simple if the mobile communication device has a GPS module that enables the location to be precisely determined to within a few meters and it transmits the location data to the control computer. Alternatively, the location of the antenna with which the mobile communication device communicates constantly acts as the location of the mobile communication device. The discrepancies between the antenna location and the actual location are possibly only relevant for local journeys and can lead in particular in towns to inaccuracies of only a few hundred meters.

Furthermore, the control computer in this system and when using this method is a particularly significant component because thanks to its programming it accesses the available route data very selectively when it receives information on the desired destination. If for example the traveler can be positively assigned to a means of transport and certain route points have already been passed, then only the route data relating to a generally small number of further means of transport has to be requested from the control computers of specific known traffic control centers. This means that the data exchange to use the service is kept as relatively low as possible, which provides the service with high-level availability for comparatively low system resources.

I claim:

1. System for providing travel information on a mobile communication device, in which
a) a destination can be entered in a communication device and transmitted to a control computer,
b) a current location can be assigned to the communication device in the control computer,
c) the control computer has connections to route control facilities for public transport,
d) the current locations of the means of public transport can be called up from the control facilities via the control computer,
e) depending on the current locations of the means of public transport, an individual timetable can be generated using suitable public transport to reach the destination, and
f) the timetable of the suitable means of transport can be transferred to the mobile communication device where it can be seen and/or heard.

2. The system according to claim 1, wherein the mobile communication device has a location detection module and the mobile communication device transmits information regarding the current location to the control computer.

3. The system according to claim 1, wherein the location of a send/receive unit with which the mobile communication device is currently communicating, is assigned to the mobile communication device as its current location.

4. The system according to claim 1, wherein the generation of the individual timetable can be repeated during the journey to the destination and that if an update is needed, an updated timetable can be transmitted to the mobile communication device.

5. The system according to claim 4, wherein an updated timetable is only transmitted up to a specifiable time before reaching the transfer point.

6. The system according to claim 1, wherein the location of the mobile communication device (currently traveling on a means of public transport) can be evaluated as being on this particular means of public transport by the control computer by correlation with the current location of the means of public transport and therefore for probable arrival times at the next possible transfer point(s) can be determined.

7. A method for providing travel information on a mobile communication device, in which
a) a destination is entered in a communication device and transmitted to a control computer,
b) a current location is assigned in the control computer to the communication device,
d) the current locations of means of public transport are called up from the control facilities via the control computer,
d) depending on the current locations of the means of public transport, an individual timetable is determined using suitable public transport to reach the destination, and
f) the timetable of the suitable means of transport is transferred to the mobile communication device where it can be seen and/or heard.

8. The method according to claim 7, wherein the mobile communication device has a location detection module and using the mobile communication device transmits information regarding the current location to the control computer.

9. The method according to claim 7, wherein the location of a send/receive unit with which the mobile communication device is currently communicating, is assigned to the mobile communication device as its current location

10. The method according to claim 7 wherein the generation of the individual timetable is repeatable during the journey to the destination and that if an update is needed, an updated timetable is transmitted to the mobile communication device.

11. The method according to claim 10, wherein an updated timetable is only transmitted up to a specifiable time before reaching the transfer point and if it is available after the specified time, it is suppressed.

12. The method according claim 7, wherein the location of the mobile communication device (currently traveling on a means of public transport) is evaluated as being on this particular means of public transport by the control computer by correlation with the current location of the means of public transport and therefore for probable arrival times at the next possible transfer point(s) is determined

13. The method according to claim 7, wherein after issuing the individual timetable a seat reservation with confirmation can be made using the mobile communication device for the planned means of public transport.

14. The method according to claim 7, wherein a reservation profile is stored on the control computer.
